(19) United States
(12) Patent Application Publication
(10) Pub. No.: US 2005/0099683 A1
(43) Pub. Date: May 12, 2005

(54) Telescope, telescope main body and electronic view finder

(75) Inventor: Makoto Mogamiya, Tokyo (JP)

Correspondence Address: GREENBLUM & BERNSTEIN, P.L.C., 1950 ROLAND CLARKE PLACE, RESTON, VA, 20191, US

(73) Assignee: PENTAX Corporation, Tokyo (JP)

(21) Appl. No.: 10/981,784

(22) Filed: Nov. 5, 2004

(30) Foreign Application Priority Data
Nov. 6, 2003 (JP) 2003-377605

(51) Int. Cl. G02B 23/00

(52) U.S. Cl. 359/399; 359/363

(57) ABSTRACT

A telescope, which is provided with a telescope main body including an objective optical system, a focusing system including a focus adjusting member to be manipulated for focusing and a focusing lens which moves along a direction of an optical axis of the objective optical system by operation of the focus adjusting member, and an imaging device which captures an object image formed through the objective optical system and the focusing lens; and an electronic view finder that is configure to detachably attached to the telescope main body and has a display device on which the object image captured by the imaging device is displayed as a motion picture.

### BACKGROUND OF THE INVENTION

The present invention relates to a telescope, a telescope body and an electronic view finder.

A telescope having a digital photography function (e.g. a terrestrial telescope), which is capable of picking-up electronic images that are similar as visual images viewed through an eyepiece, is known (refer to, for example, Japanese Utility Model No. 3,074,642). The telescope having digital photography function has a configuration, in which light that has passed through an objective optical system and focusing lens is split via a beam splitter, to direct one of the split lights toward an ocular optical system and direct the other toward an image pick-up device such as a charge coupled device (CCD), for example.

Such type of the telescope having digital photography function includes a replaceable eyepiece, and the observation is carried out at a fixed magnification by employing an eye piece having a fixed focus, or at variable magnifications by employing a zoom eyepiece having variable focuses. As such, the magnification of the visual image can be changed by replacing the eyepiece, and thus angle of view of the visual image (real field of view) can also be changed. Nevertheless, since the angle of view for the image pick-up device is independent on the eye piece, a dedicated eye piece having a predetermined focal distance is required to allow the angle of view of a visual image (i.e., an observation image) to coincide with the angle of view for image pick-up device.

However, since the angle of view for the image pick-up device changes depending on the size of the image pick-up device, if a user uses another telescope of which image pick-up device has a different size, a different dedicated eye piece is required for allowing the angle of view of the visual image to coincide with the angle of view of the image pick-up device, which-requires extra cost.

For this reason, it is difficult for a user to know whether the angle of view for the image pick-up device coincides with the angle of view of the visual image when using the conventional telescope having digital photography function, and thus it is difficult to pick-up images with a desired angle of view.

### SUMMARY OF THE INVENTION

The present invention is advantageous in that it provides a telescope which is capable of shooting an object image of which angle of view is the same as that of a visual image formed through an electronic view finder of the telescope.

According to an aspect of the invention, there is provided a telescope, which is provided with (1) a telescope main body including an objective optical system, a focusing system including a focus adjusting member to be manipulated for focusing and a focusing lens which moves along a direction of an optical axis of the objective optical system by operation of the focus adjusting member, and an imaging device which captures an object image formed through the objective optical system and the focusing lens; and (2) an electronic view finder that is configure to be detachably attached to the telescope main body and has a display device on which the object image captured by the imaging device is displayed as a motion picture.

With this configuration, a user can view, through the electronic view finder, an observation image with an angle of view which is the same as that of the imaging device without any discrepancies therebetween. Thus, mistakes happened during shooting operation, such as failing to take a desired object in an obtained image, or taking an unwanted subject in an obtained image, can be surely prevented, and thus a desired image can be surely obtained.

Optionally, the telescope main body may include a beam splitter which splits an optical path through the focusing lens into a first optical path directed to the imaging device and a second optical path directed to an ocular optical system provided in an eyepiece which is detachably attached to the telescope main body in place of the electronic view finder.

Still optionally, the telescope main body may include an eyepiece mounting base to which the eyepiece is detachably attached. In this case, the electronic view finder is detachably attached to the eyepiece mounting base in place of the eyepiece.

Still optionally, the telescope main body may include output contacts through which an image signal to be supplied to the electronic view finder is transmitted, and the electronic view finder may include input contacts which contact the output contacts of the telescope main body when the electronic view finder is attached to the telescope main body.

Still optionally, the electronic view finder may include ocular units for left and right eyes.

In a particular case, the optical axis of the objective optical system and an optical axis of each of the ocular units may be parallel with each other when the electronic view finder is attached to the telescope main body.

Optionally, the electronic view finder may include a display circuit which drives the display device, and a battery which supplies power to the display device.

In a particular case, an imaging optical system may be formed by optical components including the objective optical system, the focusing lens and at least one other optical component located between the objective optical system and a receiving surface of the imaging device. A focal length of the imaging optical system may be not less than 800 mm on the basis of a 35 mm film.

According to another aspect of the invention, there is provided a telescope main body, which is provided with an objective optical system, a focusing system including a focus adjusting member to be manipulated for focusing and a focusing lens which moves along a direction of an optical axis of the objective optical system by operation of the focus adjusting member, an imaging device which captures an object image formed through the objective optical system and the focusing lens, a mounting base to which an electronic view finder is detachably attached. The electronic view finder has a display device on which the object image captured by the imaging device is displayed as a motion picture.

With this configuration of the telescope main body, it becomes possible that a user can view, through the electronic view finder, an observation image with an angle of view which is the same as that of the imaging device without any discrepancies therebetween. Thus, mistakes happened during shooting operation, such as failing to take a desired object in an obtained image, or taking an unwanted subject in an obtained image, can be surely prevented, and thus a desired image can be surely obtained.

Optionally, the mounting base may have contacts through which the telescope main body is electrically connected to the electronic view finder.

Still optionally, the telescope main body may include a controller that controls the imaging device and detects whether or not the electronic view finder is attached to the mounting base through the contacts. In this case, the controller may operate to send an image signal outputted by the imaging device through the contacts to the electronic view finder when the electronic view finder is attached to the mounting base.

Still optionally, the mounting base may have a recessed portion, and the contacts may be formed in the recessed portion.

Still optionally, an imaging optical system may be formed by optical components including the objective optical system, the focusing lens and at least one other optical component located between the objective optical system and a receiving surface of the imaging device. A focal length of the imaging optical system may be not less than 800 mm on the basis of a 35 mm film.

According to another aspect of the invention, there is provided an electronic view finder, which is provided with a display device, a display circuit that drives the display device, and a connector portion that includes input contacts through which an image signal is inputted to the display circuit. The electronic view finder is detachably attached to a telescope main body via the connector portion. The image signal is obtained by an imaging device provided in the telescope main body. The telescope main body includes an objective optical system, a focusing system including a focus adjusting member to be manipulated for focusing and a focusing lens which moves along a direction of an optical axis of the objective optical system by operation of the focus adjusting member, and the imaging device which captures an object image formed through the objective optical system and the focusing lens.

With this configuration of the electronic view finder, it becomes possible that a user can view, through the electronic view finder, an observation image with an angle of view which is the same as that of the imaging device without any discrepancies therebetween. Thus, mistakes happened during shooting operation, such as failing to take a desired object in an obtained image, or taking an unwanted subject in an obtained image, can be surely prevented, and thus a desired image can be surely obtained.

Optionally, the electronic view finder may include a battery which supplies power to the display device.

### BRIEF DESCRIPTION OF THE ACCOMPANYING DRAWINGS

FIG. 1 is a perspective front view showing a telescope main body according to an embodiment of the present invention;

FIG. 2 is a perspective rear view showing the telescope main body of FIG. 1;

FIG. 3 is a cross-sectional side view showing the telescope main body of FIG. 1;

FIG. 4 is a perspective exploded view showing an optical system of a telescope according to the embodiment of the present invention;

FIG. 5 is a side view showing a prism unit viewed from an opposite side of FIG. 3;

FIG. 6 is a block diagram showing a configuration of the telescope main body of FIG. 1;

FIG. 7 is a perspective rear view of the telescope main body having an electronic view finder mounted thereto;

FIG. 8 is a perspective view of the electronic view finder;

FIG. 9 is a perspective view of the electronic view finder illustrating a situation in which a upper cover thereof is removed;

FIG. 10 is a perspective view of the electronic view finder viewed from a bottom side; and

FIG. 11 is a flowchart illustrating a control operation in the case where the electronic view finder is mounted to the telescope main body.

### DETAILED DESCRIPTION OF THE EMBODIMENTS

Referring to the accompanying drawings, a preferable embodiment of a telescope (spotting scope) and an electronic view finder according to the present invention will be described hereunder.

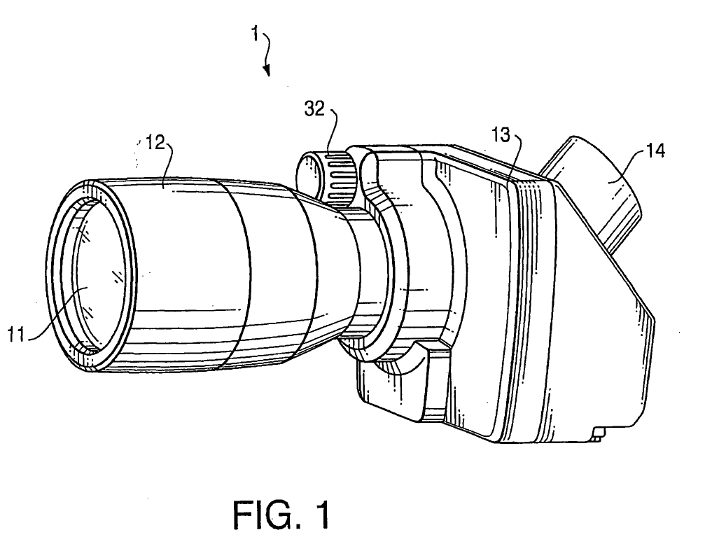

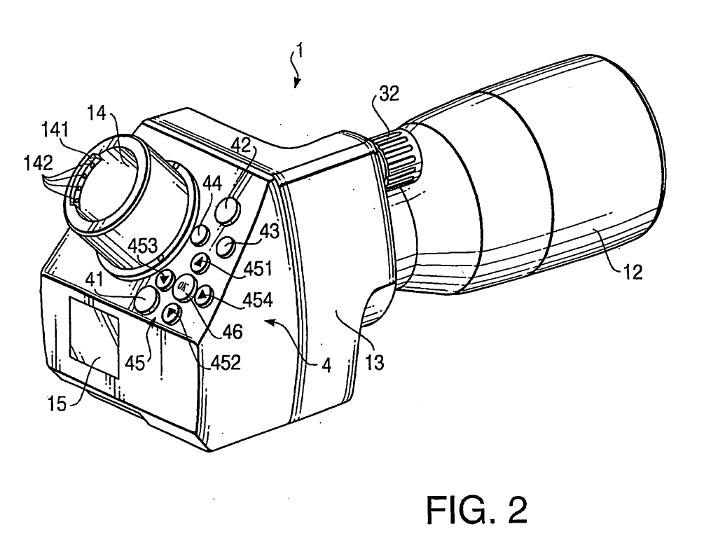

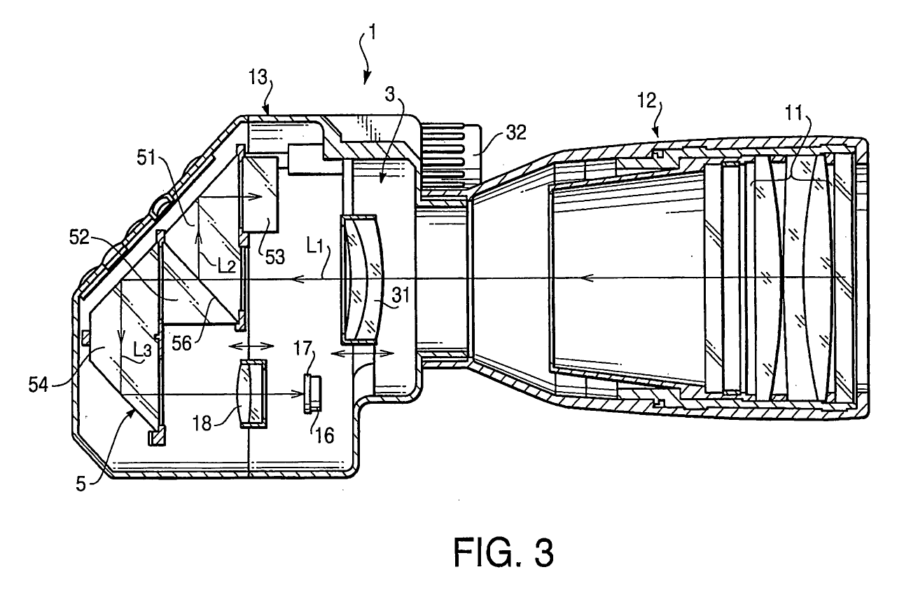

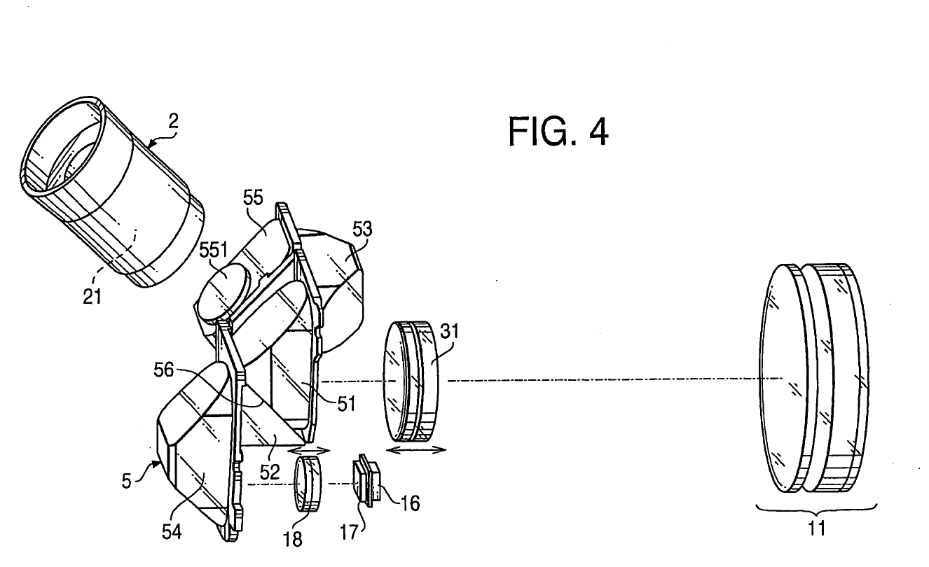

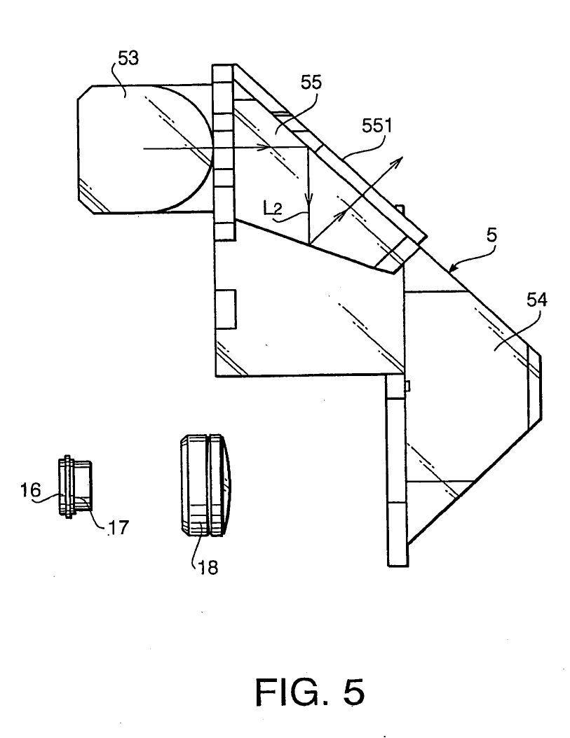

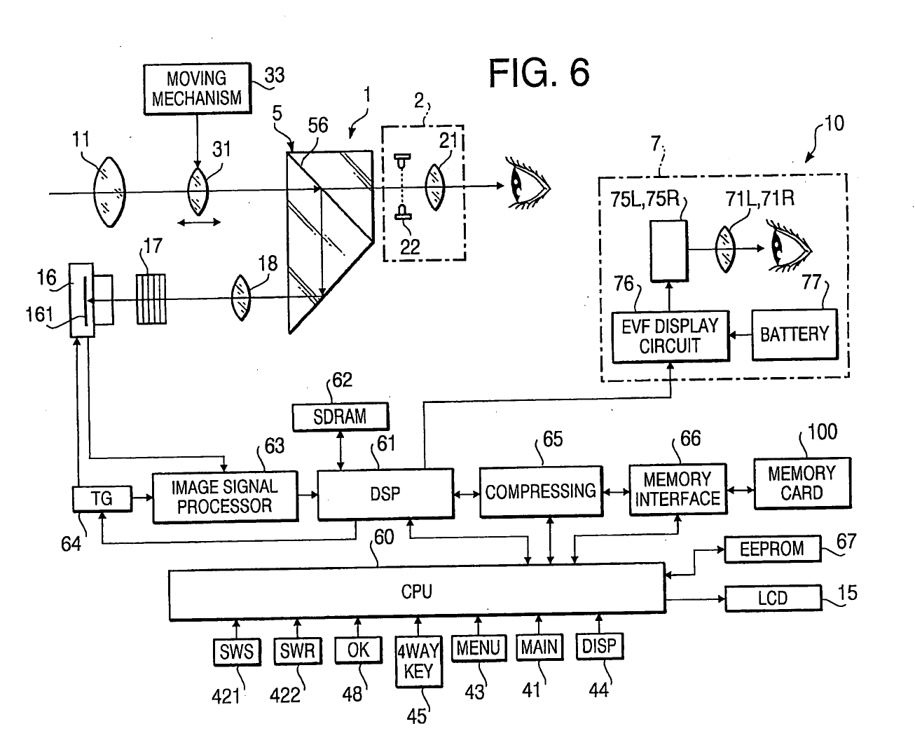

FIG. 1 is a perspective front view showing a telescope main body 1 according to the embodiment of the present invention; FIG. 2 is a perspective rear view showing the telescope main body 1 of FIG. 1; FIG. 3 is a cross-sectional side view showing the telescope main body 1 of FIG. 1; FIG. 4 is a perspective exploded view showing an optical system of a spotting scope according to the present invention; FIG. 5 is a side view showing a prism unit viewed from an opposite side of FIG. 3; and FIG. 6 is a block diagram showing a configuration of the telescope main body 1 of FIG. 1.

The spotting scope 10 according to the embodiment has the telescope body 1 shown in FIG. 1 to FIG. 5 and an electronic view finder (EVF) 7 described later (see FIG. 6). The spotting scope 10 can be suitably utilized for various purposes, typically for bird watching.

As shown in FIG. 1, the telescope main body 1 is provided with a lens barrel 12 containing therein an objective optical system 11 and a casing 13 located at a base portion of the lens barrel 12. The casing 13 is provided with a focusing ring 32 rotatably disposed in an upper region of a front face thereof, for serving as a focus adjusting device.

Referring to FIG. 2, the casing 13 is provided, on a rear face thereof, with an eyepiece mounting base 14 to which the eyepiece 2 can be detachably mounted, a display panel 15 and various operating buttons 4.

On the eyepiece mounting base 14, the eyepiece 2 containing therein an ocular optical system 21 as shown in FIG. 4 or the electronic view finder 7 can be detachably mounted. Replacing the eyepiece 2 with another having a different focal length can change a magnification of the spotting scope 10. Also, the eyepiece mounting base 14 accepts a variable focus type (zoom type) eyepiece.

While the drawings show an angle type spotting scope in which an optical axis of the eyepiece 2 mounted on the eyepiece mounting base 14 is upwardly inclined with respect to an optical axis of the objective optical system 11 by a predetermined angle, the scope of the present invention is not limited to such type. The present invention may also be applied to a straight type spotting scope in which the both optical axes are parallel to each other.

The display panel 15 is constituted of for example a liquid crystal display device. The display panel 15 can display a menu screen, a setting screen of different modes, an image captured by a CCD (Charge Coupled Device) imaging device 16 to be described later, and so forth.

Referring to FIG. 2, the operating buttons 4 include a main switch 41 for turning on and off the power, a release button 42, a menu key 43, a display key 44 for switching on and off the display panel 15, an up key 451, a down key 452, a left key 453 and a right key 454 respectively for moving a cursor displayed on the display panel 15, and an OK button 46 for entering a selected item.

Referring to FIG. 3, the lens barrel 12 contains the objective optical system 11 in the proximity of a front end portion thereof. Also, a focusing lens (focus adjusting lens) 31 is coaxially placed with respect to the objective optical system 11, in the casing 13. The focusing lens 31 moves along a direction of the optical axis by a manipulation of the focusing ring 32, so as to adjust a focus. A focusing lens moving mechanism 33 (not shown in FIG. 3) for converting a rotational movement of the focusing ring 32 into a rectilinear movement of the focusing lens 31 may be a barrel cam mechanism or a feed screw mechanism etc. The focusing lens 31, the focusing ring 32 and the focusing lens moving mechanism 33 constitute a focusing system 3.

In the casing 13, a prism unit 5 is disposed behind the focusing lens 31. The prism unit 5 includes a first right-angle prism 51, a second right-angle prism 52, a third right-angle prism 53, a fourth right-angle prism 54 and a prism 55.

A short side surface of the first right-angle prism 51 and the long side surface of the second right-angle prism 52 are joined, and the joint plane constitutes a beam splitter 56. Also, as shown in FIG. 4, the prism 55 is provided with an emergence plane 551, through which a light beam proceeds toward the ocular optical system 21 (eyepiece mounting base 14).

Referring further to FIG. 3, a light beam that has passed through the objective optical system 11 and the focusing lens 31 first enters the first right-angle prism 51. An optical path L1 of this light beam is split at the beam splitter 56 into a first optical path L2 directed to the ocular optical system 21 and a second optical path L3 directed to the CCD imaging device 16.

The first optical path L2 directed to the ocular optical system 21 turns its direction by 180 degrees because of reflection at the beam splitter 56 as well as the other short side plane of the first right-angle prism 51. As shown in FIG. 5, the first optical path L2 is then reflected twice in the third right-angle prism 53 thus to turn its direction again by 180 degrees, and further reflected twice in the prism 55, to thereby upwardly incline and to finally proceed to the ocular optical system 21 through the emergence plane 551.

The first right-angle prism 51 and the third right-angle prism 53 constitute an erecting optical system (porro prism). For this reason an erected image can be observed through the eyepiece 2.

Back to FIG. 3, the second optical path L3 directed to the CCD imaging device 16 passes through the beam splitter 56 to enter the fourth right-angle prism 54, and is reflected twice in the fourth right-angle prism 54 to thereby turn its direction by 180 degrees and to proceed forward.

The casing 13 also accommodates therein the CCD imaging device 16, an optical filter unit 17 and a reducing optical system 18.

The CCD imaging device 16 is disposed at a position appropriate for receiving a light beam that has come along the second optical path L3, to thereby capture an image obtained through the objective optical system 11 and the focusing lens 31. Specifically, a receiving surface 161 (see FIG. 6) of the CCD imaging device 16 is located at a position that is optically equivalent to a field frame 22 (target focus position) of the eyepiece 2.

As a result of such configuration, the spotting scope 10 can shoot an electronic image identical to a visual image viewed through the eyepiece 2, with the CCD imaging device 16. It should be noted that another imaging device such as a CMOS sensor or the like may be used in place of the CCD imaging device 16.

The optical filter unit 17 is attached to the CCD imaging device 16 so as to face a receiving surface 161 thereof. The optical filter unit 17 is formed by a lamination of an optical low-pass filter and an infrared cut filter. The optical low-pass filter serves to reduce a spatial frequency component close to a sampling spatial frequency determined by a pixel spacing of the CCD imaging device 16, out of a spatial frequency of a light beam of an object. The optical low-pass filter serves to prevent emergence of a moire, and the infrared cut filter serves to exclude an infrared frequency component. Providing the infrared cut filter permits preventing the CCD imaging device 16 from receiving an infrared light beam which is invisible to human eyes.

The reducing optical system 18 is placed between the fourth right-angle prism 54 and the combination of the CCD imaging device 16 and the optical filter unit 17. A light beam from the focusing lens 31 that has proceeded along the second optical path L3 is downscaled by the reducing optical system 18 so as to fit a size of the CCD imaging device 16, to thereby form an image on the receiving surface 161 of the CCD imaging device 16.

As described above, the telescope main body 1 is provided with the imaging optical system for the CCD imaging device 16, constituted of the entire optical system disposed between the objective optical system 11 to the receiving surface 161 of the CCD imaging device 16, inclusive of the former, namely the objective optical system 11, the focusing lens 31, the beam splitter 56, the reducing optical system 18 and the optical filter unit 17.

It is preferable that the imaging optical system has a focal length of not less than 800 mm on the basis of a 35 mm film. Here, a focal length on the basis of a 35 mm film means a focal length that forms an object image of a same picture angle on the receiving surface of the CCD imaging device 16, assuming that an effective receiving area of the CCD imaging device 16 is enlarged to the exposure area of a 35 mm silver halide film (36 mm×24 mm).

On the other hand, an upper limit of the focal length of the imaging optical system is not specifically determined, however from the viewpoint of a practical use, a maximum focal length of the imaging optical system of the telescope according to the embodiment of the present invention may be approx. 20000 mm on the basis of a 35 mm film.

Now referring to FIG. 6, from the viewpoint of electric configuration, the telescope main body 1 is provided with a CPU (Central Processing Unit) 60, a DSP (Digital Signal Processor) 61, an SDRAM (Synchronous Dynamic Random Access Memory) 62, an image signal processor 63, a timing generator 64, an image data compressor 65, a memory interface 66, and an EEPROM (Electrically Erasable Programmable Read-Only Memory) 67. In addition, the casing 13 accommodates therein a slot (not shown) in which a memory card (storage medium) 100 can be loaded.

The CPU 60 serves for integrally controlling the telescope main body 1 based on a preinstalled program and input signals from the operating buttons etc., and performs various controlling operations such as a photographic control, a control over the reducing optical system driving controller 68 and so forth.

The DSP 61 is engaged in driving control of the CCD imaging device 16 and integral control of image processing and storing, including generation of image data based on a pixel signal from the CCD imaging device 16, compression of the image data, storing the image data in the memory card 100, etc., through mutual communication with the CPU 60 for collaboration in these jobs.

The SDRAM 62 includes operating regions for image data generation etc. and regions for the display panel 15 etc., which are determined in advance.

The timing generator 64 is controlled by the DSP 61, to output a sample pulse etc. to the CCD imaging device 16, the image signal processor 63 and the reducing optical system driving controller 68, for controlling an operation thereof.

The spotting scope 10 configured as above is designed such that a visual image viewed through the eyepiece 2 is to be recognized as correctly focused when an image forming position (aerial image) of the visual image has reached a position of the field frame 22 by manipulation of the focusing ring 32. In other words, the user is expected to manipulate the focusing ring 32 for focusing purpose such that an image formed at a position of the field frame 22 (target focus position) becomes clearly seen.

By pressing the release button 43 when the user views an visual image to be photographed, the user can store an electronic image identical to the visual image viewed through the eyepiece 2. As already described, since the receiving surface 161 of the CCD imaging device 16 is at a position optically equivalent to the position of the field frame 22 (target focus position), the same object image is also formed on the receiving surface 161 of the CCD imaging device 16 once the focus is adjusted as above. Therefore, upon shooting the image under such state, a correctly focused picture is supposed to be obtained.

As described above, the telescope main body 1 is configured such that the electronic view finder 7 can be attached to the eyepiece mounting base 14 in place of the eyepiece 2 (i.e., the electronic view finder 7 is also detachably attached to the eyepiece mounting base 14), and thus the visual image can also be viewed through the electronic view finder 7. The electronic view finder 7 will be described in detail as follows.

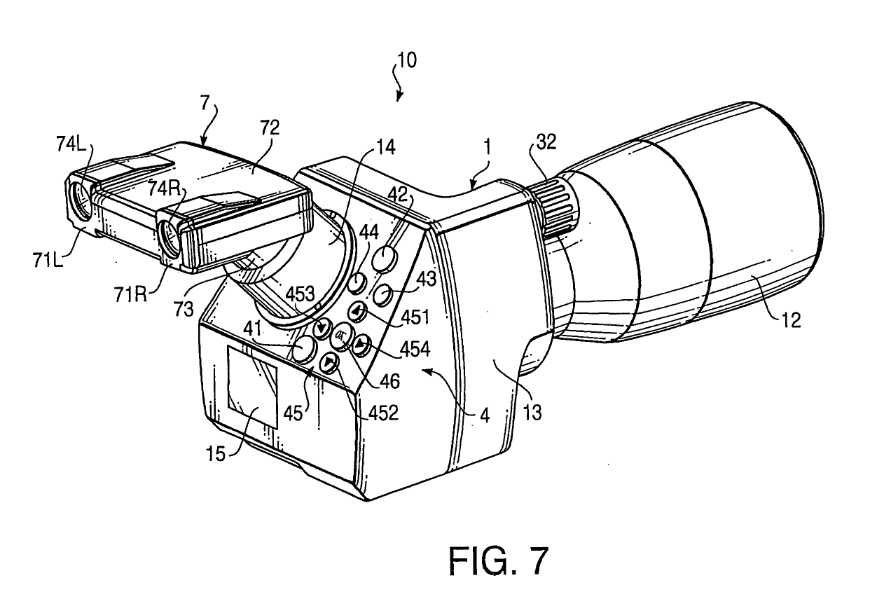

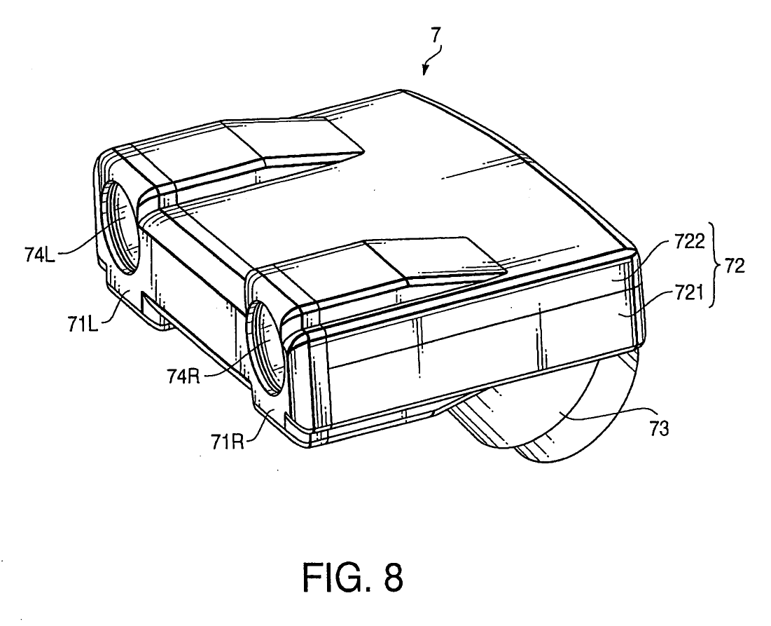

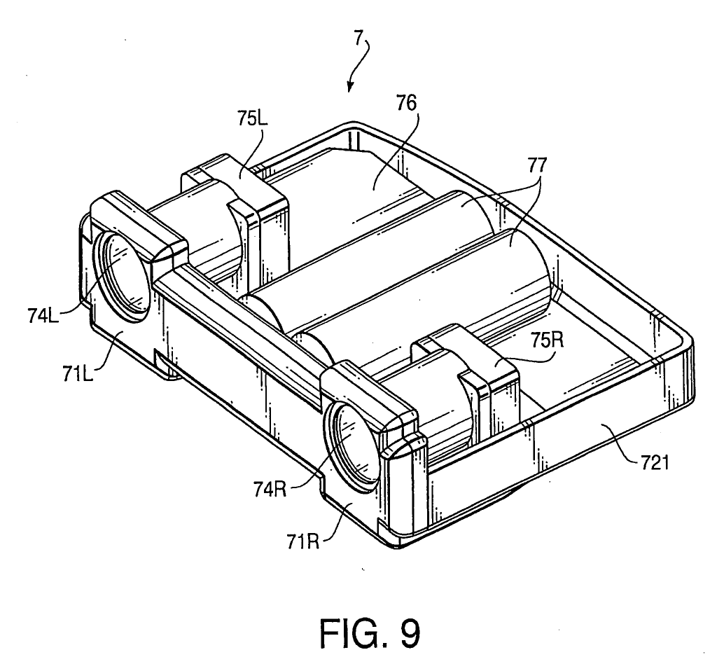

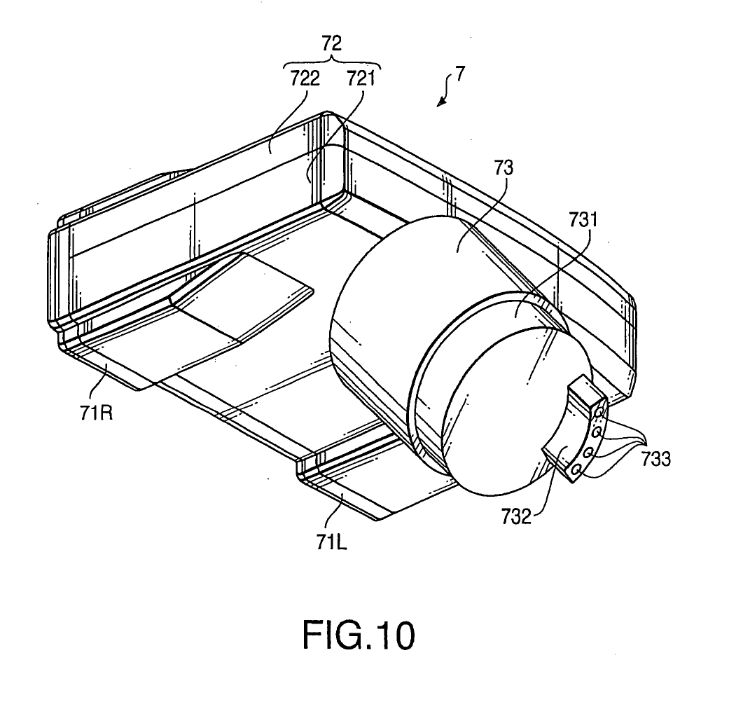

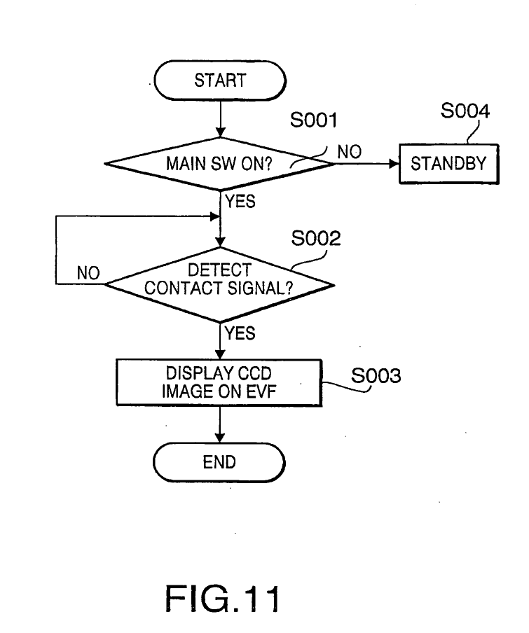

FIG. 7 is a perspective view of the spotting scope 10 illustrating a situation in which the electronic view finder 7 is attached to the telescope main body 1. FIG. 8 is a perspective view of the electronic view finder 7. FIG. 9 is a perspective view of the electronic view finder 7 illustrating a situation in which an upper cover thereof is removed. FIG. 10 is a perspective view of the electronic view finder viewed from a bottom side. FIG. 11 is a flowchart illustrating a control operation in the case where the electronic view finder 7 is mounted to the telescope main body 1.

As shown in FIG. 8, the electronic view finder 7 is a binocular type apparatus including an ocular portion 71L for the left eye and an ocular portion 71R for the right eye. The electronic view finder 7 includes a case 72 having a tray 721 and the top cover 722, and a cylindrical neck portion 73 projecting from the case 72 obliquely in a downward direction. The ocular portions 71L and 71R are provided on a side surface of the case 72. The ocular portions 71L and 71R also include magnifying lenses 74L and 74R, respectively.

As shown in FIG. 9, liquid crystal view finders 75L and 75R, a display circuit 76 for driving the liquid crystal view finders 75L and 75R and a cell (battery) 77 functioning as a power supply for these elements are provided in the case 72.

Each of the liquid crystal view finders 75L and 75R includes a liquid crystal display and a backlight. Left and right eyes of a user observe magnified images respectively displayed on the liquid crystal view finders 75L and 75R for and magnified by the magnifying lenses 74L and 74R. Although the liquid crystal display is employed in the embodiment, the type of the display device is not limited thereto, and any types thereof such as organic electroluminescence (EL) or the like may be employed. The cell 77 may be primary cell or secondary cell.

As shown in FIG. 10, a diameter-reduced portion 731 having slightly reduced outer diameter is formed at a tip portion of the neck portion 73.

As shown in FIG. 7, the electronic view finder 7 is attached to the telescope body main body 1 at its neck portion 73. The neck portion 73 is used as a connector to be connected to the telescope main body 1. That is, the neck portion 73 is attached to the eyepiece mounting base 14. In a situation shown in FIG. 7, optical axes of the ocular portions 71L and 71R of the electronic view finder 7 become parallel to the optic axis of the objective optical system 11 of the telescope main body 1. By this structure, the user can observe objects (a visual image) through the eyepiece 2 in comfort.

The method for fixing the neck portion 73 to the eyepiece mounting base 14 may be any fixing method, such as fitting, fixing with a fixing member that are not illustrated or the like.

As shown in FIG. 10, the diameter reduced portion 731 is provided with a projection part 732 projecting from an end portion of an outer surface of the diameter reduced portion 731. The projection part 732 has input contacts 733 through which image signals are input.

As shown in FIG. 2, a recessed portion 141, in which the projection part 732 can be inserted, is formed in the eye piece mounting base 14. On a bottom surface of the recessed portion 141, output contacts 142 through which the image signals are output are provided. Since the output contacts 142 are formed in the recessed portion 141, the output contacts 142 do not obstruct insertion of the eyepiece 2. In addition, while the eyepiece 2 is attached to the eye piece mounting base 14, an opening of the recessed portion 141 is completely covered by the eyepiece 2, and thereby the output contacts 142 are protected.

As shown in FIG. 11, when the main switch 41 is pushed, power of the telescope main body 1 is turned on (step S001). If the main switch 41 is not turned on, the telescope main body 1 stays at a standby mode (S004). Next, in step S002, the CPU 60 waits until a contact signal is detected. When the electronic view finder 7 is mounted to the telescope main body 1, the input contacts 733 contact the output contacts 142, and the CPU 60 detects that the electronic view finder 7 is mounted on the telescope main body 1 by detecting the contact signal through the input and output contacts 733, 142.

If the contact signal is detected (S002:YES), the image signal is transmitted from the telescope main body 1 to the electronic view finder 7 through the input contact 733 and the output contact 142, and images picked-up by the CCD imaging device 16 are displayed (in step S003) as motion pictures (generally referred to as “live view display” or “monitor display”) in real time through the liquid crystal view finders 75L and 75R, as follows.

The object image formed on the receiving surface 161 of the CCD imaging device 16 is photoelectrically converted into electrical charge data, and such charge data (signal) is sequentially read out from the CCD imaging device 16 with a portion corresponding to a predetermined number of pixels thinned out, for reproducing a live view image to be displayed on the liquid crystal view finders 75L and 75R.

Further, the signal undergoes a correlative double sampling (CDS), automatic gain control (AGC) and analog/digital conversion in the image signal processor 63, to then be input to the DSP 61. In the DSP 61, a predetermined signal processing including color processing and gamma correction etc. is performed on the input signal, to thereby generate a live view image data (luminosity signal Y, two color difference signals Cr, Cb).

The live view image data includes a fewer number of pixels (because of the thinning out) than the number of effective pixels of the CCD imaging device 16, in accordance with the number of pixels of each of the liquid crystal view finders 75L and 75R. The generation of the live view image data is periodically updated each time the data is read out from the CCD imaging device 16, so that the image is displayed on each of the liquid crystal view finders 75L and 75R as a real-time motion picture. Such a live view image is also displayed on the display 15.

In shooting and recording operation, the telescope main body 1 operates as follows. That is, when the release button 42 is pressed by half and thereby a photometric switch 421 is turned on, the CPU 60 performs exposure calculation based on output signals from the CCD imaging device 16. When the release button 42 is pressed fully and thereby a release switch 422 is turned on, the CPU 60 sends an instruction to the DSP 61 for performing a real exposure. The DSP 61, upon receipt of the instruction of a real exposure, performs unwanted charge discharging control and exposure control (charge storage time control) etc. for the CCD imaging device 16, and then reads out charge data (raw data) through the image signal processor 63, from the CCD imaging device 16 without thinning out the pixels and temporarily stores the data in the SDRAM 62.

Then, the CPU 60 generates a still image for recording, which has a large number of pixels, by performing a predetermined image processing on the data read out of the SDRAM 62.

Further, the DSP 61 thins out the pixels from the generated still image data for recording to generate a screen nail of a still image for displaying (for example 640×480 pixels), and displays the screen nail on the liquid crystal view finders 75L and 75R and the display panel 15 for a predetermined period of time. The DSP 61 then performs a image compressing process on the still image using the image data compressor 65 to generate an image data having a certain format such as a JPEG or a TIFF format. The compressed image data is then outputted through the memory interface 66 and is stored in the memory card 100.

Since the spotting scope 10 according to the embodiment is provided with the electronic view finder 7, a user can view an observation image with an angle of view which is the same as that of the CCD imaging device without any discrepancies therebetween. Thus, mistakes happened during the shooting operation, such as failing to take a desired object in an obtained image, or taking an unwanted subject in an obtained image, can be surely prevented, and thus a desired image can be surely obtained.

In addition, the electronic view finder 7 may also be used in combination with another telescope main body having a different size of the CCD imaging device. The above-described advantages of the embodiment can also be achieved in such a case.

Further, the electronic view finder 7 also exhibits better visibility in a dark environment in the night, thereby providing easier observation under such condition.

Information such as a time, various types of data including a status of the telescope main body 1 may be displayed by an on-screen display unit circuit (not shown) on the liquid crystal view finders 75L and 75R in a superimposing manner, thereby providing better convenience.

Further, since the electronic view finder 7 is a binocular type apparatus, easiness in the observation Improves, and thus the observation can more comfortably be carried out. Alternatively, the electronic view finder may be a monocular type apparatus.

In addition, since the electronic view finder 7 includes the display circuit 76 and the cell 77 therein, the need for mounting these elements in the telescope main body 1 can be avoided, by which downsizing and weight reduction of the telescope main body 1 can be attained. Further, simplification of the input contacts 733 and the output contacts 142 can be achieved. As an alternative to such a configuration, the display circuit 76 and the cell 77 may be provided in the telescope main body 1.

The cell accommodated in the electronic view finder 7 may be shared by the electronic view finder 7 and the telescope main body 1.

Although the spotting scope and the electronic view finder according to the present invention have been described referring to the embodiment shown in the accompanying drawings, it is to be understood that the present invention is not limited to the foregoing embodiment, and that the constituents of the spotting scope and the electronic view finder may be optionally substituted with different ones which have an equivalent function. Also, an additional constituent may be optionally incorporated.

Furthermore, the present invention can be applied to various other types of telescopes including an astronomical telescope, without limitation to a spotting scope.

The present disclosure relates to the subject matter contained in Japanese Patent Application No. 2003-377605, filed on Nov. 6, 2003, which is expressly incorporated herein by reference in its entirety.

1. A telescope, comprising:
a telescope main body including
an objective optical system,
a focusing system including a focus adjusting member to be manipulated for focusing and a focusing lens which moves along a direction of an optical axis of the objective optical system by operation of the focus adjusting member, and
an imaging device which captures an object image formed through the objective optical system and the focusing lens; and
an electronic view finder that is configure to be detachably attached to the telescope main body and has a display device on which the object image captured by the imaging device is displayed as a motion picture.

2. The telescope according to claim 1, wherein the telescope main body further includes a beam splitter which splits an optical path through the focusing lens into a first optical path directed to the imaging device and a second optical path directed to an ocular optical system provided in an eyepiece which is detachably attached to the telescope main body in place of the electronic view finder.

3. The telescope according to claim 2, wherein the telescope main body includes an eyepiece mounting base to which the eyepiece is detachably attached, the electronic view finder being detachably attached to the eyepiece mounting base in place of the eyepiece.

4. The telescope according to claim 1,
wherein the telescope main body includes output contacts through which an image signal to be supplied to the electronic view finder is transmitted, and
wherein the electronic view finder includes input contacts which contact the output contacts of the telescope main body when the electronic view finder is attached to the telescope main body.

5. The telescope according to claim 1, wherein the electronic view finder includes ocular units for left and right eyes.

6. The telescope according to claim 5, wherein the optical axis of the objective optical system and an optical axis of each of the ocular units are parallel with each other when the electronic view finder is attached to the telescope main body.

7. The telescope according to claim 1, wherein the electronic view finder includes a display circuit which drives the display device, and a battery which supplies power to the display device.

8. The telescope according to claim 1,
wherein an imaging optical system is formed by optical components including the objective optical system, the focusing lens and at least one other optical component located between the objective optical system and a receiving surface of the imaging device, and
wherein a focal length of the imaging optical system is not less than 800 mm on the basis of a 35 mm film.

9. A telescope main body, comprising:
an objective optical system;
a focusing system including a focus adjusting member to be manipulated for focusing and a focusing lens which moves along a direction of an optical axis of the objective optical system by operation of the focus adjusting member;
an imaging device which captures an object image formed through the objective optical system and the focusing lens; and
a mounting base to which an electronic view finder is detachably attached, the electronic view finder having a display device on which the object image captured by the imaging device is displayed as a motion picture.

10. The telescope main body according to claim 9,
wherein the mounting base has contacts through which the telescope main body is electrically connected to the electronic view finder.

11. The telescope main body according to claim 10, further comprising a controller that controls the imaging device and detects whether or not the electronic view finder is attached to the mounting base through the contacts,
wherein the controller operates to send an image signal outputted by the imaging device through the contacts to the electronic view finder when the electronic view finder is attached to the mounting base.

12. The telescope main body according to claim 10,
wherein the mounting base has a recessed portion, and
wherein the contacts are formed in the recessed portion.

13. The telescope main body according to claim 9,
wherein an imaging optical system is formed by optical components including the objective optical system, the focusing lens and at least one other optical component located between the objective optical system and a receiving surface of the imaging device, and
wherein a focal length of the imaging optical system is not less than 800 mm on the basis of a 35 mm film.

14. An electronic view finder, comprising:
a display device;
a display circuit that drives the display device; and
a connector portion that includes input contacts through which an image signal is inputted to the display circuit,
wherein the electronic view finder is detachably attached to a telescope main body via the connector portion, the image signal being obtained by an imaging device provided in the telescope main body,
wherein the telescope main body includes:
an objective optical system;
a focusing system including a focus adjusting member to be manipulated for focusing and a focusing lens which moves along a direction of an optical axis of the objective optical system by operation of the focus adjusting member; and
the imaging device which captures an object image formed through the objective optical system and the focusing lens.

15. The electronic view finder according to claim 14, further comprising a battery which supplies power to the display device.
